(19) United States
(12) Patent Application Publication
(10) Pub. No.: US 2014/0255883 A1
(43) Pub. Date: Sep. 11, 2014

(54) SYSTEM AND METHOD FOR AUTOMATED MONITORING OF FOOD AND BEVERAGE INTAKE, DETERMINING ASSOCIATED NUTRITIONAL INFORMATION AND COMPARING WITH A PREDETERMINED DIETARY PLAN

(71) Applicant: Christopher Thomas Jules Macquet, Navigators (AU)

(72) Inventor: Christopher Thomas Jules Macquet, Navigators (AU)

(21) Appl. No.: 13/946,686

(22) Filed: Jul. 19, 2013

(30) Foreign Application Priority Data
Mar. 6, 2013 (AU) 2013900768

(51) Int. Cl. G09B 19/00; A23L 1/29

(52) U.S. Cl. CPC G09B 19/0092; A23L 1/293
USPC 434/127

(57) ABSTRACT

A system for automated monitoring of food and beverage intake comprises a weighing assembly including a scale, a product identifier adapted to identify product IDs and a data transfer module in communication with the scale and product identifier. The data transfer module being adapted to receive product IDs associated with food and beverages use information including any change in weight of the food and beverage. The system also comprises a food and beverage inventory database, a food nutrient database, a dietary intake plan for a user of said system; a dietary intake recorder, and a user interface in communication with said dietary intake recorder. The dietary intake recorder is automatically updated with food and beverage use information identified by the weighing assembly. The user interface is also adapted to facilitate input of external food and beverage intake of a user to the dietary intake recorder.

### FIELD OF INVENTION

The present invention relates to a system and method for automated monitoring of food and beverage intake, determining associated nutritional information and comparing with a predetermined dietary plan. In particular, the invention relates to methods and systems that facilitate monitoring of food and beverage intake and associated nutritional information based on a dietary intake plan of a user, generally without manual input of data.

### BACKGROUND ART

There are currently many health and nutritional balancing programs available for use on personal computers (PCs), through the Internet or smart phones, and so on. All of the programs currently available require input of time and attention to manually plan and balance eating plans with proposed fitness or diet plans. Some programs monitor actual exercise against planned diet. One program (Nike on iPhone) automates exercise data collection.

One issue facing such programs is that people either forget to, or find it too tedious to manually update their actual food consumption if it deviates from the plan. Apart from the case of the most disciplined participants, deviation from the plan generally happens all the time. For example, one may be tempted to eat fast foods, go to restaurants, and so on. As a result, it is thought that only 10% of purchasers of these programs actually adhere to them. If a participant misses one meal, the feedback and data generated is not accurate.

All nutritional planning programmes (i.e. books, software, Weight Watcher's regimes) try to provide a rough guide on what you need to be eating, often restricted to 3 or 4 factors: protein, calories, carbohydrates and sugars. Most ask you to keep a log, but, as mentioned above, only about 10% of people manage to successfully do so. Most nutritional software (NS) allows you to plan in great detail these 3 or 4 intakes in order to balance these with your Recommended Daily Intake (RDI) or desired goal (reduce weight, gain weight, improve performance, etc.)

A few NS's go beyond the 3-4 nutrients, into the 37 defined by the FSANZ (Foods Standards Australia and New Zealand) as essential for nutritional eating, etc. However none facilitate the recording of intake of these nutrients.

Despite the best efforts of the Government in Australia, consumers have very little idea of their consumption of nutrients. Currently, if a consumer wishes to watch a particular component, such as carbohydrates, sugar, fats and/or salt, they try to keep a mental tally in their head of what they are buying. However, all the Nutritional Information really does is enable a consumer to choose between one product or another, based on the one factor they are currently watching.

In addition, while most packaged food items list information about the contents, those selling fresh produce rarely offer information on freshness, food miles, nutrients, nutritional density indices, farming method, country of origin, and so on.

It would be advantageous if a system was available that automates the data capture side of food consumption, thereby making the known laborious data capture processes faster and easier.

In recent years, there have been a number of kitchen appliances proposed that facilitate recording of food consumption and inventory keeping. For example, “intelligent” fridges were initially proposed with a scale for every item in the fridge to calculate consumption each item within the fridge. However, this was not practical and was very expensive. Current thinking is that external scales need to be linked to the fridge, but this has not been practically applied at this stage.

LG appear to be leaders in the development of smart fridges, having proposed units that include a touch screen that facilitates product information entry and monitors aging products within the fridge. The touch screen may also provide for a shopping list which may be used to connect with on-line shopping to order listed items.

Belkin International, Inc. has proposed a wall mount for mounting a thin film tablet, such as an i-Pad, onto a non-intelligent fridge. This effectively provides computing power at the fridge door which may facilitate similar features to those mentioned in the immediately preceding paragraph.

It would be advantageous if a system could be provided that not only automated the data capture side of food consumption, but also facilitated automatic inventory updates and purchase options.

The subject matter claimed herein is not limited to embodiments that solve any disadvantages or that operate only in environments such as those described above. Rather, this background is only provided to illustrate one exemplary technology area where some embodiments described herein may be practice.

### SUMMARY OF INVENTION

One aspect of the invention provides a system for automated monitoring of food and beverage intake, determining associated nutritional information and comparing with a predetermined dietary plan comprising:
a weighing assembly comprising (i) a scale for measuring the weight of food and beverage; (ii) a product identifier adapted to identify product IDs associated with the food and beverage; and (iii) a data transfer module in communication with the scale and the product identifier, the data transfer module being adapted to receive the product ID associated with the food and beverage and food and beverage use information including any change in weight of the food and beverage;
a food and beverage inventory database storing food and beverage inventory available to a user of the system, the food and beverage inventory including purchased food and beverage information input to the food and beverage inventory database on purchase of new food and beverage and food and beverage use information received from the weighing apparatus;
a food nutrient database comprising nutritional information an food and beverages;
a dietary intake plan for a user or users of the system;
a dietary intake recorder that records dietary intake of said user of said system, whereby nutritional information of said dietary intake of said user can be calculated from said food nutrient database and said nutritional information compared with said dietary intake plan;
and
a user interface in communication with said dietary intake recorder;
wherein said dietary intake recorder is automatically updated with said food and beverage use information identified by said weighing assembly on use of said food and beverage by said user, and wherein said user interface is adapted to facilitate input of external food and beverage intake of said user to said dietary intake recorder.

In certain embodiments the system may also include a required list generation module adapted to generate a list of required food and beverage based on the food and beverage inventory and the dietary intake plan.

As noted above, the list of required food and beverage is generated based on the existing food and beverage inventory, including any food and beverage on order, and the dietary intake plan that has been put into place. In a preferred embodiment, the required list generation module is additionally adapted to generate the list of required food and beverage based on the food and beverage use information (i.e. past food consumption) and/or user preferred food and beverage (i.e. local, seasonal and/or user preference).

The list of required food and beverage may be printed out and the food and beverage purchased from a supplier, such as a supermarket. However, in a preferred embodiment the weighing assembly additionally comprises a user interface and Internet connection that facilitates on-line ordering of the required food and beverage. According to this embodiment, the system is adapted to automatically update the food and beverage inventory database with the ordered food and beverage during or after on-line ordering of the required food and beverage.

Purchased food and beverage may be input to the food and beverage inventory database by any suitable means. For example, this may be input using the weighing assembly of the system and/or using barcode or RFID tag recognition. In one embodiment, the system additionally comprises a scanner for optically scanning a till receipt of purchased food and beverage, the scanner being adapted to update the food and beverage inventory database with the purchased food and beverage.

In most instances, it would also be advantageous if use-by dates of food and beverage could be captured and entered in the for product inventory database. The system may therefore additionally comprise a scanner or camera provided with optical character recognition (OCR) adapted to scan use-by-dates (UBD) of the food and beverage and import use-by-date information to the food and beverage inventory database.

The dietary intake plan may be determined by any suitable means. For example, this may be based on (i) a Recommended Dietary Intake (RDI) calculation taking account of age, height and weight of the user and one or more desired goals of the user; and/or (ii) a required daily intake of a specified nutrient, vitamin and/or mineral; (iii) a limitation on intake of a particular food component, such as carbohydrate, sugar, fats and/or salt; and/or is generated by an overseeing third party (i.e. a doctor, nutritionist, dietary club such as Weight Watchers, research organisation, or personal trainer).

In certain embodiments, the dietary intake plan includes tolerances, such as + or −20% of an entered value within the dietary intake plan. According to this embodiment, the system may be adapted to alert the user (i.e. by SMS or other means) when the tolerances are exceeded, for example on a specified averaging basis (i.e. a 3 or 7 day moving average).

The product identifier is preferably selected from a barcode reader adapted to read a barcode applied to the food and beverage or a container containing the food and beverage and/or an RFID tag reader adapted to read an RFID tag applied to the food and beverage or a container containing the food and beverage and thereby identify the product IDs associated with the food and beverage. It is also envisaged that in the future, image and/or voice recognition may also be made available to assist in entering food and beverage information. In a preferred embodiment, the product identifier is in close proximity to the scale, such that the food and beverage can be weighed and identified within quick succession or simultaneously.

In certain embodiments, the system may additionally comprise a recipe selection module comprising a recipe database, the recipe selection module being adapted to select recipes for the user based on the food and beverage inventory, the dietary intake plan and the dietary intake record of the user or users.

In another aspect the invention provides a method for automated monitoring of food and beverage intake, determining associated nutritional information and comparing with a predetermined dietary plan comprising:
inputting information on purchased food and beverage into a food and beverage inventory database;
on use of a food and beverage entered in the food and beverage inventory, identifying a product ID associated with the food and beverage and product use information and updating the food and beverage inventory database and with the product use information;
establishing a dietary intake plan for a user or users of the method;
recording dietary intake of the user, the dietary intake comprising external food and beverage intake of the user and the food and beverage use information;
identifying nutritional information on the dietary intake of the user; and
comparing the nutritional information on the dietary intake of the user with said dietary intake plan of the user.

In certain embodiments, the step of identifying the product ID and product use information comprises identifying the food and beverage with a product identifier and weighing the food and beverage after use of the food and beverage and comparing the weight of the food and beverage with a pre-use weight of the food and beverage stored within the food and beverage inventory database.

As with the above described system, identifying the food and beverage preferably comprises scanning a barcode or RFID tag associated with the food and beverage or a container or packaging containing the food and beverage, preferably simultaneously with weighing of the food and beverage.

The method may also comprise generating a list of required food and beverage based on the food and beverage inventory, the dietary intake plan and a dietary intake record of the user or users of the method. In certain embodiments, generating the list of required food and beverage takes into account the food and beverage use information (i.e. past food consumption) and/or user preferred food and beverage (i.e. local, seasonal and/or user preference).

Preferably, the list of required food and beverage is electronically stored and the method additionally comprises on-line ordering of the required food and beverage based on the electronically stored list. In this embodiment, the method preferably comprises automatically updating the food and beverage inventory database with the ordered food and beverage during or after on-line ordering of the required food and beverage.

Inputting information on purchased food and beverage may comprise optically scanning a till receipt of purchased food and beverage and updating the food and beverage inventory database with the purchased food and beverage. Other means of input of purchased food and beverage are mentioned above.

The method may additionally comprise scanning use-by-dates (UBD) of the food and beverage, for example using a scanner or camera provided with optical character recognition (OCR), and importing use-by-date information to the food and beverage inventory database.

As with the above described system, the method may comprise determining the dietary intake plan based on (i) a Recommended Dietary Intake (RDI) calculation taking account of age, height and weight of the user and one or more desired goals of the user; and/or (ii) a required daily intake of a specified nutrient, vitamin and/or mineral; (iii) a limitation on intake of a particular food component, such as carbohydrate, sugar, fats and/or salt; and/or is generated by an overseeing third party (i.e. a doctor, nutritionist, dietary club such as Weight Watchers, research organisation, or personal trainer). Likewise, the method may comprise applying tolerances to the dietary intake plan, such as + or −20% of an entered value within the dietary intake plan and alerting a user of the method (i.e. by SMS or other means) when the tolerances are exceeded, for example on a specified averaging basis (i.e. a 3 or 7 day moving average).

Preferably, the method may additionally comprise selecting a recipe from a recipe database based on the food and beverage inventory, the dietary intake plan and a dietary intake record of the user or users. As such, the method may also comprise updating the dietary intake record of the user or users based on the product use information and on consumption of other food and beverage.

The present invention consists of features and a combination of parts hereinafter fully described and illustrated in the accompanying drawings, it being understood that various changes in the details may be made without departing from the scope of the invention or sacrificing any of the advantages of the present invention.

### BRIEF DESCRIPTION OF ACCOMPANYING DRAWINGS

To further clarify various aspects of some embodiments of the present invention, a more particular description of the invention will be rendered by references to specific embodiments thereof, which are illustrated in the appended drawings. It is appreciated that these drawings depict only typical embodiments of the invention and are therefore not to be considered limiting of its scope. The invention will be described and explained with additional specificity and detail through the accompanying drawings in which:

FIG. 1 illustrates a flow chart of the system of an embodiment of the invention.

FIG. 2 illustrates a flow chart of methodology of an embodiment of the invention.

### DETAILED DESCRIPTION OF THE PREFERRED EMBODIMENTS

As mentioned above, the present invention relates to a system and method for automated monitoring of food inventory, purchase of food items and/or recipe generation. In particular, the invention relates to methods and systems that facilitate monitoring of food inventory and purchase of food items and/or recipe generation based on a dietary intake plan of a user, generally without manual input of data.

Hereinafter, this specification will describe the present invention according to the preferred embodiments. It is to be understood that limiting the description to the preferred embodiments of the invention is merely to facilitate discussion of the present invention and it is envisioned without departing from the scope of the appended claims.

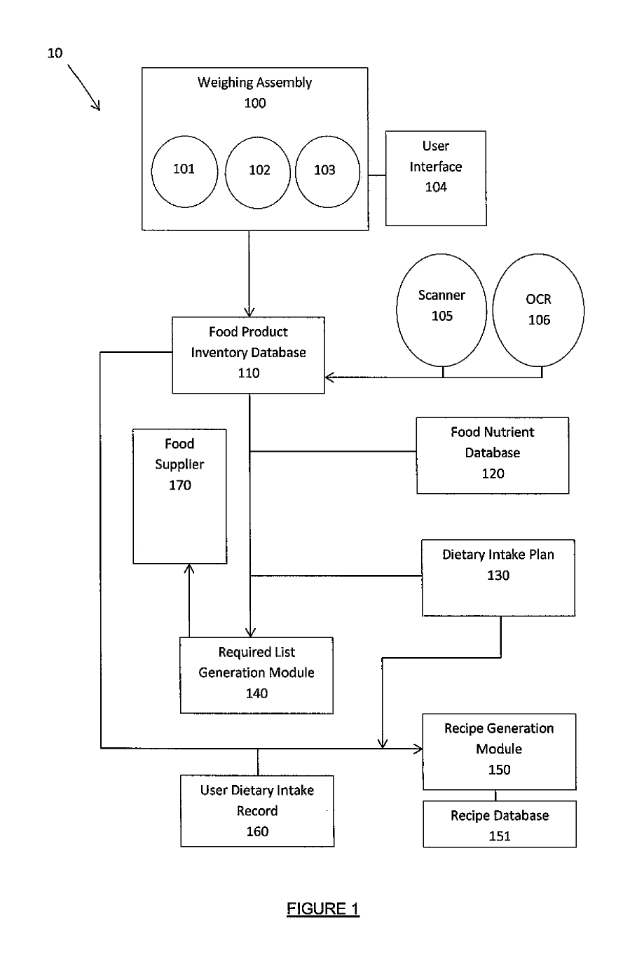

Referring to FIG. 1, a system 10 is illustrated that includes a weighing assembly 100 comprising a scale 101, product identifier 102 and data transfer module 103. The scale 101 is a digital scale and communicates the weight of a food and beverage placed on the scale to the data transfer module 103 in use. In the case of newly purchased food and beverage, this may have a product ID applied and the total weight of the food and beverage determined. In the case of existing inventory, on use of the food and beverage the post-use weight of the food and beverage may be determined and compared with a pre-recorded weight of the food and beverage, thereby determining food and beverage use information.

The product identifier 102 is a barcode reader adapted to read a barcode applied to the food and beverage or a container containing the food and beverage and/or an RFID tag reader adapted to read an RFID tag applied to the food and beverage or a container containing the food and beverage. The product identifier 102 identifies a product ID associated with the food and beverage and communicates the product ID to the data transfer module 103. Generally, the product identifier is in close proximity to the scale 101, for example a barcode reader may be directly or indirectly attached to the scale 101 and an RFID tag reader may be likewise attached to the scale 101. This facilitates simultaneous weighing of the food and beverage and identification of the product ID of the food and beverage and transfer of this information to the data transfer module 103.

A user interface 104 is also provided on the weighing assembly 100. This is generally a touch screen interface that provides the weighing assembly 100 with Internet capabilities and connection. The user interface 104 provides options such as on-line ordering of food and beverage, recipe selections and information, data relating to user dietary intake, input of dietary plan information, much of which will be discussed hereafter.

A scanner 105 and OCR device 106, which may be the same or separate components, are provided. These may be used to scan and/or read food and beverage information on shopping receipts and/or use-by-dates of food and beverage for entry into the system 10.

Product use information received by the data transfer module 103 of the weighing assembly 100 is transmitted to a food and beverage inventory database 110, which includes data of food and beverage available to a user of the system 10. Purchased food and beverage information received from the data transfer module 103, and/or from the scanner 105 or OCR device 106 is also transmitted to the food inventory database 110.

The food and beverage inventory database 110 works in tandem with a food nutrient database 120, which may be stored at the same or a different location to the food and beverage database. The food nutrient database 120 includes nutritional information of all available food and beverages. This may be updated automatically by sourcing food nutrition information from any number of sources.

A dietary intake plan 130 is provided that includes dietary requirements of a user of the system 10. As mentioned previously, the dietary intake plan 130 may be based on a Recommended Dietary Intake (RDI) calculation taking account of age, height and weight of the user and one or more desired goals of the user. It may also be based on a required daily intake of a specified nutrient, vitamin and/or mineral, or a limitation on intake of a particular food component, such as carbohydrate, sugar, fats and/or salt. In addition, the dietary intake plan 130 may be generated by an overseeing third party (i.e. a doctor, nutritionist, dietary club such as Weight Watchers, research organisation, or personal trainer).

Based on the dietary intake plan 130 of the user and the food and beverage inventory listed on the food and beverage inventory database 110, a required list zo generation module 140 generates a list of required food and beverage to be purchased. This list may be printed and used in the usual way to identify required food and beverage on physically visiting a supplier 170, such as a supermarket or the like. The list may also be reported to the user interface 104 and on-line shopping facilities utilised to purchase the required products from the supplier 170. In that case, the food and beverage inventory database 110 is automatically updated with the ordered food and beverage.

The dietary intake plan 130 of the user and the food and beverage inventory listed on the food and beverage inventory database 110 may also be used to generate a recipe using a recipe generation module 150. The recipe generation module 150 may also take into account a user dietary intake record 160 that provides details of a user's dietary intake over a predetermined period of time. For example, a user of the system may request that the system 10 generate a recipe based on their intake for the day or week in question and the food and beverage available to them. The recipe generation module 150 may then identify a suitable recipe that may be prepared by the user with the food and beverage available to them, while achieving their dietary intake plan 130. In that regard, the recipe generation module 150 is generally associated with a recipe database 151 that includes a number of recipes. The recipe database 151 may source recipes from the Internet or other sources.

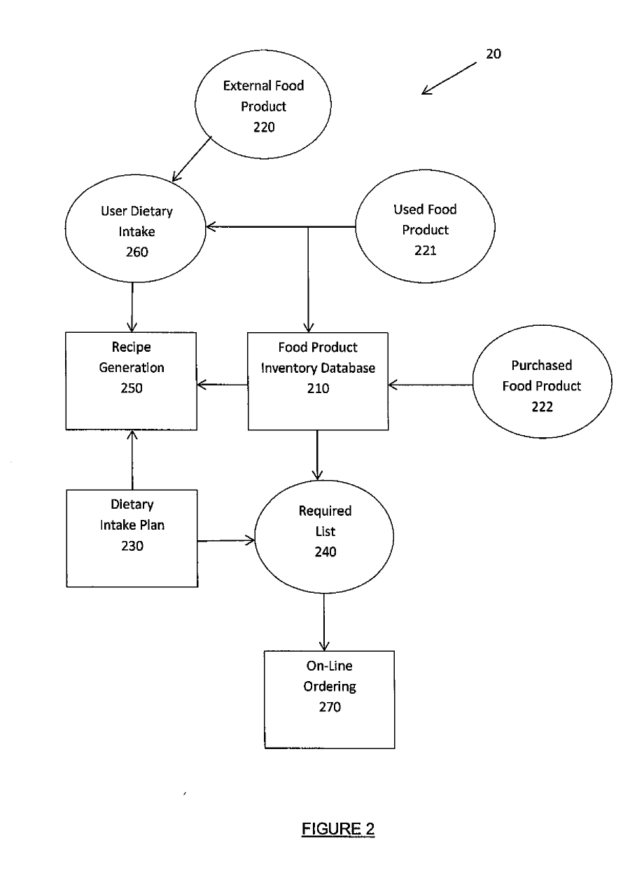

Methodology 20 according to an embodiment of the invention is illustrated in FIG. 2. A food and beverage inventory database 210 is established that includes information on food and beverage available to a user. Purchased food and beverage 222 is entered into the food and beverage inventory database 210 and used food and beverage 221 is identified and the food and beverage inventory database 210 updated accordingly.

Based on a dietary intake plan 230 of a use and the food and beverage available and entered in the food and beverage inventory database 210, a required list 240 may be generated. This may be used for on-line ordering 270 of the required food and beverages.

A user dietary intake 260 may be monitored by entry of external food and beverage 220 consumed by the user, and used food and beverage 221 consumed from the food and beverage stored on the food and beverage inventory database 210. On the basis of the user dietary intake 260, the intake available to the user to satisfy the dietary intake plan 230 may be calculated. Taking this into account and considering the food and beverage available in the food and beverage inventory database 210, a selection of recipes may be generated 250 or selected from a recipe database.

It is envisaged that the system and method of the invention may also take into account other factors. For example, the system and method may consider Nutritional Density Index (NDI) of food and beverage being purchase. For example, produce may have poor NDI if it is grown in inappropriate soil, if it is picked too early, or if it is subject to long supply chains or “food miles”. The system may take into account “ethical buying”, identity of the source of goods, identification of genetically modified (GM) produce and so on.

It is also envisaged that the system and method of the invention may be suitably adapted to mobile communications technology. For example, a smart phone may be provided with optical character recognition and/or barcode recognition so that external food intake may be entered easily, and so on.

Unless the context requires otherwise or specifically stated to the contrary, integers, steps or elements of the invention recited herein as singular integers, steps or elements clearly encompass both singular and plural forms of the recited integers, steps or elements.

Throughout this specification, unless the context requires otherwise, the word “comprise”, or variations such as “comprises” or “comprising”, will be understood to imply the inclusion of a stated step or element or integer or group of steps or elements or integers, but not the exclusion of any other step or element or integer or group of steps, elements or integers. Thus, in the context of this specification, the term “comprising” is used in an inclusive sense and thus should be understood as meaning “including principally, but not necessarily solely”.

It will be appreciated that the foregoing description has been given by way of illustrative example of the invention and that all such modifications and variations thereto as would be apparent to persons of skill in the art are deemed to fall within the broad scope and ambit of the invention as herein set forth.

1. A system for automated monitoring of food and beverage intake, determining associated nutritional information and comparing with a predetermined dietary plan comprising:
a weighing assembly comprising (i) a scale for measuring the weight of food and beverage; (ii) a product identifier adapted to identify product IDs associated with said food and beverage; and (iii) a data transfer module in communication with said scale and said product identifier, said data transfer module being adapted to receive said product ID associated with said food and beverage and food and beverage use information including any change in weight of said food and beverage;
a food and beverage inventory database storing food and beverage inventory available to a user of the system, said food and beverage inventory including purchased food and beverage information input to said food and beverage inventory database on purchase of purchased food and beverage and food and beverage use information received from said weighing apparatus;
a food nutrient database comprising nutritional information on food and beverages;
a dietary intake plan for a user of said system;
a dietary intake recorder that records dietary intake of said user of said system, whereby nutritional information of said dietary intake of said user can be calculated from said food nutrient database and said nutritional information compared with said dietary intake plan; and
a user interface in communication with said dietary intake recorder;
wherein said dietary intake recorder is automatically updated with said food and beverage use information identified by said weighing assembly on use of said food and beverage by said user, and wherein said user interface is adapted to facilitate input of external food and beverage intake of said user to said dietary intake recorder.

2. A system according to claim 1, additionally comprising a required list generation module adapted to generate a list of required food and beverage based on said food and beverage inventory and said dietary intake plan;

3. A system according to claim 2, wherein said required list generation module is additionally adapted to generate said list of required food and beverage based on said food and beverage use information (i.e. past food and beverage consumption) and/or user preferred food and beverages (i.e. local, seasonal and/or user preference).

4. A system according to claim 1, wherein said weighing assembly comprises a user interface and Internet connection that facilitates on-line ordering of said required food and beverage.

5. A system according to claim 4, wherein said system is adapted to automatically update said food and beverage inventory database with the ordered food and beverage during or after on-line ordering of said required food and beverage.

6. A system according to claim 1, additionally comprising a scanner for optically scanning a till receipt of purchased food and beverage, said scanner being adapted to update said food and beverage inventory database with said purchased food and beverage.

7. A system according to claim 1, additionally comprising a camera provided with optical character recognition (OCR) adapted to scan use-by-dates (UBD) of said food and beverage and import use-by-date information to said food and beverage inventory database.

8. A system according to claim 1, wherein said dietary intake plan is determined based on (i) a Recommended Dietary Intake (RDI) calculation taking account of age, height and weight of said user and one or more desired goals of said user; and/or (ii) a required daily intake of a specified nutrient, vitamin and/or mineral; (iii) a limitation on intake of a particular food component, such as carbohydrate, sugar, fats and/or salt; and/or is generated by an overseeing third party (i.e. a doctor, nutritionist, dietary club such as Weight Watchers, research organisation, or personal trainer).

9. A system according to claim 1, wherein said dietary intake plan includes tolerances, such as + or −20% of an entered value within said dietary intake plan, and wherein said system is adapted to alert said user (i.e. by SMS or other means) when said tolerances are exceeded, for example on a specified averaging basis (i.e. a 3 or 7 day moving average).

10. A system according to claim 1, wherein said product identifier is selected from a barcode reader adapted to read a barcode applied to said food and beverage or a container containing said food and beverage and/or an RFID tag reader adapted to read an RFID tag applied to said food and beverage or a container containing said food and beverage and thereby identify said product IDs associated with said food and beverage.

11. A system according to claim 9, wherein said product identifier is in close proximity to said scale, such that said food and beverage can be weighed and identified within quick succession or simultaneously.

12. A system according to claim 1, additionally comprising a recipe selection module comprising a recipe database, said recipe selection module being adapted to select recipes for said user based on said food and beverage inventory, said dietary intake plan and said dietary intake record of said user or users.

13. A method for automated monitoring of food and beverage intake, determining associated nutritional information and comparing with a predetermined dietary plan comprising:
inputting information on purchased food and beverage into a food and beverage inventory database;
on use of a food and beverage entered in said food and beverage inventory, identifying a product ID associated with said food and beverage and food and beverage use information and updating said food and beverage inventory database and with said product use information;
establishing a dietary intake plan for a user;
recording dietary intake of said user, said dietary intake comprising external food and beverage intake of said user and said food and beverage use information;
identifying nutritional information on said dietary intake of said user; and
comparing said nutritional information on said dietary intake of said user with said dietary intake plan of said user.

14. A method according to claim 13, wherein said step of identifying said product ID and product use information comprises identifying said food and beverage with a product identifier and weighing said food and beverage after use of said food and beverage and comparing the weight of said food and beverage with a pre-use weight of said food and beverage stored within said food and beverage inventory database.

15. A method according to claim 13, wherein identifying of said food and beverage comprises scanning a barcode or RFID tag associated with said food and beverage or a container or packaging containing said food and beverage, preferably simultaneously with weighing of said food and beverage.

16. A method according to claim 13, additionally comprising generating a list of required food and beverage based on said food and beverage inventory, said dietary intake plan and a dietary intake record of said user or users.

17. A method according to claim 16, wherein generating said list of required food and beverage takes into account said food and beverage use information (i.e. past food consumption) and/or user preferred food and beverage (i.e. local, seasonal and/or user preference).

18. A method according to claim 13, wherein said list of required food and beverage is electronically stored and said method additionally comprises on-line ordering of said required food and beverage based on said electronically stored list.

19. A method according to claim 18, comprising automatically updating said food and beverage inventory database with the ordered food and beverage during or after on-line ordering of said required food and beverage.

20. A method according to claim 13, wherein inputting information on purchased food and beverage comprises optically scanning a till receipt of purchased food and beverage and updating said food and beverage inventory database with said purchased food and beverage.

21. A method according to claim 13, additionally comprising scanning use-by-dates (UBD) of said food and beverage, for example using a camera provided with optical character recognition (OCR), and importing use-by-date information to said food and beverage inventory database.

22. A method according to claim 13, comprising determining said dietary intake plan based on (i) a Recommended Dietary Intake (RDI) calculation taking account of age, height and weight of said user and one or more desired goals of said user; and/or (ii) a required daily intake of a specified nutrient, vitamin and/or mineral; (iii) a limitation on intake of a particular food component, such as carbohydrate, sugar, fats and/or salt; and/or is generated by an overseeing third party (i.e. a doctor, nutritionist, dietary club such as Weight Watchers, research organisation, or personal trainer).

23. A method according to claim 13, comprising applying tolerances to said dietary intake plan, such as + or −20% of an entered value within said dietary intake plan and alerting a user of said method (i.e. by SMS or other means) when said tolerances are exceeded, for example on a specified averaging basis (i.e. a 3 or 7 day moving average).

24. A method according to claim 13, additionally comprising selecting a recipe from a recipe database based on said food and beverage inventory, said dietary intake plan and said dietary intake record of said user.
